(19) United States
(12) Patent Application Publication
(10) Pub. No.: US 2023/0419985 A1
(43) Pub. Date: Dec. 28, 2023

(54) INFORMATION PROCESSING APPARATUS, INFORMATION PROCESSING METHOD, AND PROGRAM

(71) Applicant: Sony Group Corporation, Tokyo (JP)

(72) Inventors: Kentaro Kimura, Tokyo (JP); Yasuyuki Koga, Kanagawa (JP)

(73) Assignee: Sony Group Corporation, Tokyo (JP)

(21) Appl. No.: 18/038,696

(22) PCT Filed: Nov. 19, 2021
(86) PCT No.: PCT/JP2021/042528

§ 371 Date: May 24, 2023

(30) Foreign Application Priority Data
Dec. 4, 2020 (JP) 2020-201905

(51) Int. Cl. G10L 25/51

(52) U.S. Cl. CPC G10L 25/51

(57) ABSTRACT

The present technique relates to an information processing apparatus, an information processing method, and a program that make it easy to distinguish between the voice of a real participant and the voice of a remote participant.

An information processing apparatus according to one aspect of the present technique includes a sound image localization processing unit that localizes a sound image of a voice of a remote participant, who is participating remotely in a conversation conducted in a predetermined space, to a position different from a position of a real participant who is a participant present in the predetermined space. The present technique can be applied in computers which perform remote conferencing.

### TECHNICAL FIELD

The present technique relates to an information processing apparatus, an information processing method, and a program, and particularly relates to an information processing apparatus, an information processing method, and a program that make it easy to distinguish between the voice of a real participant and the voice of a remote participant.

### BACKGROUND ART

What is known as “remote conferencing”, in which a user at a remote location participates in a conference using a device such as a PC, are gaining popularity. The voice of a participant collected by a microphone is transmitted via a server to a device used by another participant and output from headphones or a speaker. Accordingly, each participant can engage in conversations with other participants.

For example, PTL 1 discloses a technique in which virtual speech positions are set at intervals, and the voice of a participant expected to make an important speech at a conference is localized in front of a listener using a head-related transfer function.

### CITATION LIST

### Patent Literature

### [PTL 1]

JP 2006-279492A

### [PTL 2]

JP 2006-254064A

### SUMMARY

### Technical Problem

The technique described in PTL 1 does not take into account the presence of a real person in front of the listener, objects in the space where the listener is present, or the like. Accordingly, if the voice of a participant in a remote location is localized to the position of a person actually present, the voice of the participant in a remote location, who is a different person, will be heard from the position of the person actually present.

Having been achieved in light of such circumstances, the present technique makes it possible to easily distinguish between the voice of a real participant and the voice of a remote participant.

### Solution to Problem

An information processing apparatus according to one aspect of the present technique includes a sound image localization processing unit that localizes a sound image of a voice of a remote participant, who is participating remotely in a conversation conducted in a predetermined space, to a position different from a position of a real participant who is a participant present in the predetermined space.

In one aspect of the present technique, a sound image of a voice of a remote participant, who is participating remotely in a conversation conducted in a predetermined space, is localized at a position different from a position of a real participant who is a participant present in the predetermined space.

### BRIEF DESCRIPTION OF DRAWINGS

FIG. 1 is a diagram illustrating an example of the configuration of a tele-communication system according to an embodiment of the present technique.

FIG. 2 is a diagram illustrating an example of the transmission/reception of audio data.

FIG. 3 is a diagram illustrating an example of setting a localization position.

FIG. 4 is a diagram illustrating an example of setting a localization position.

FIG. 5 is a diagram illustrating a remote conference.

FIG. 6 is a diagram illustrating an example of setting a localization position when the position of a real participant is not taken into account.

FIG. 7 is a diagram illustrating an external view of an earphone.

FIG. 8 is a diagram illustrating an example of an output device.

FIG. 9 is a block diagram illustrating an example of the hardware configuration of a communication management server.

FIG. 10 is a block diagram illustrating an example of the functional configuration of the communication management server.

FIG. 11 is a block diagram illustrating an example of the hardware configuration example of a client terminal.

FIG. 12 is a block diagram illustrating an example of the functional configuration of the client terminal.

FIG. 13 is a flowchart illustrating overall processing performed before starting a conference.

FIG. 14 is a flowchart illustrating localization position setting processing performed in step S23 of FIG. 13.

FIG. 15 is a diagram illustrating a flow of setting localization positions for the voices of remote participants.

FIG. 16 is a diagram illustrating a flow of setting localization positions for the voices of remote participants, continued from FIG. 15.

FIG. 17 is a diagram illustrating a flow of setting localization positions for the voices of remote participants, continued from FIG. 16.

FIG. 18 is a diagram illustrating a flow of setting localization positions for the voices of remote participants, continued from FIG. 17.

FIG. 19 is a diagram illustrating a flow of setting localization positions for the voices of remote participants, continued from FIG. 18.

FIG. 20 is a diagram illustrating a flow of setting localization positions for the voices of remote participants.

FIG. 21 is a flowchart illustrating overall processing performed after starting a conference.

FIG. 22 is a flowchart illustrating other overall processing performed after starting a conference.

FIG. 23 is a flowchart illustrating other overall processing performed after starting a conference.

FIG. 24 is a diagram illustrating an example of setting localizable regions.

FIG. 25 is a diagram illustrating an example of a voice animation.

FIG. 26 is a diagram illustrating an example of a movement path of a sound source.

FIG. 27 is a diagram illustrating an example of a conference screen.

FIG. 28 is a block diagram illustrating another example of the functional configuration of a communication management server.

### DESCRIPTION OF EMBODIMENTS

An embodiment for implementing the present technique will be described below. The descriptions will be given in the following order.
1. Tele-Communication System
2. Configuration of Each Device
3. Operations of Tele-Communication System
4. Variations

### <<Tele-Communication System>>

### <System Configuration>

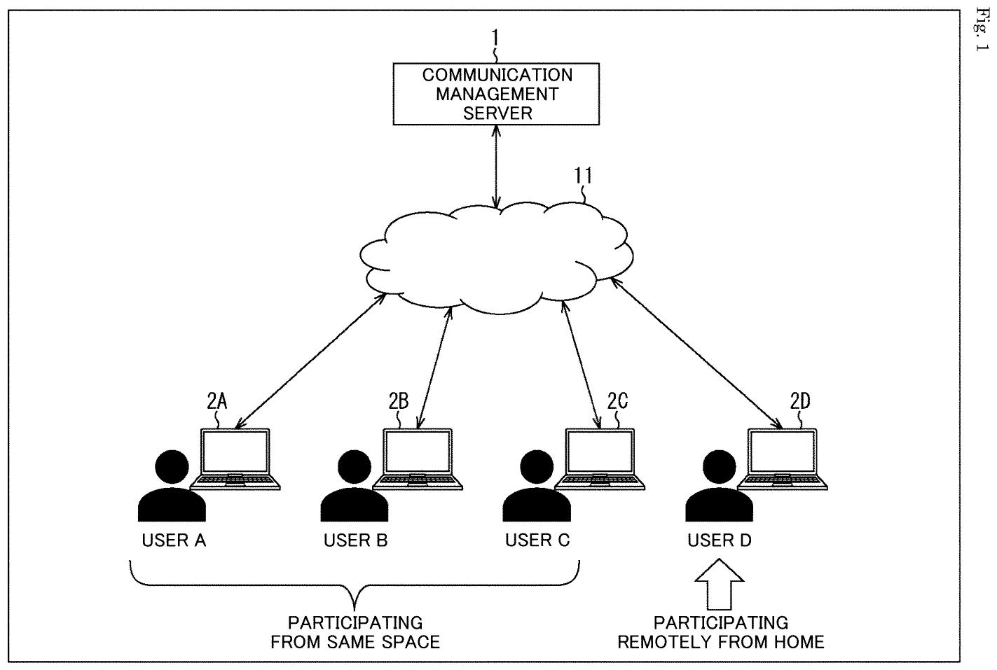

FIG. 1 is a diagram illustrating an example of the configuration of a tele-communication system according to an embodiment of the present technique.

The tele-communication system illustrated in FIG. 1 is configured by connecting, to a communication management server 1, a client terminal used by participants in a conference over a network 11 such as the Internet. The example in FIG. 1 illustrates client terminals 2A to 2D, which are PCs, as client terminals used by users A to D, who are participants in a conference.

Other devices such as smartphones, tablet terminals, or the like may be used as the client terminals. When the client terminals 2A to 2D need not be distinguished from each other, the client terminals will be referred to as “client terminal 2” as appropriate.

The users A to D are users participating in the same conference. Each of the users A to D participates in the conference while wearing stereo-type earphones (in-ear headphones), for example. For example, open-ear type (open type) earphones that do not seal the ear hole are used. The appearance of the earphones used by the users A to D will be described later.

By using open-type earphones, the users A to D can hear ambient sound along with audio output by the client terminal 2.

For example, a microphone is provided in a predetermined position in the housing of the earphones. The earphones and the client terminal 2 are connected in wired form by a cable, or wirelessly through a predetermined communication standard such as a wireless LAN or Bluetooth (registered trademark). Audio is transmitted and received between the earphones and the client terminal 2.

Each user prepares a client terminal 2 and participates in the conference while wearing the earphones. For example, as will be described below with reference to FIG. 1, the users A to C participate in the conference from the same space, such as a conference room in an office. The user D also participates in the conference remotely from home.

The number of users participating in the same conference is not limited to four. The number of users participating from the same space and the number of users participating remotely can also be changed as desired.

The communication management server 1 manages a conference which is conducted by a plurality of users by engaging in a conversation online. The communication management server 1 is an information processing apparatus which controls the transmission and reception of audio among the client terminals 2 to manage what is known as a “remote conference”.

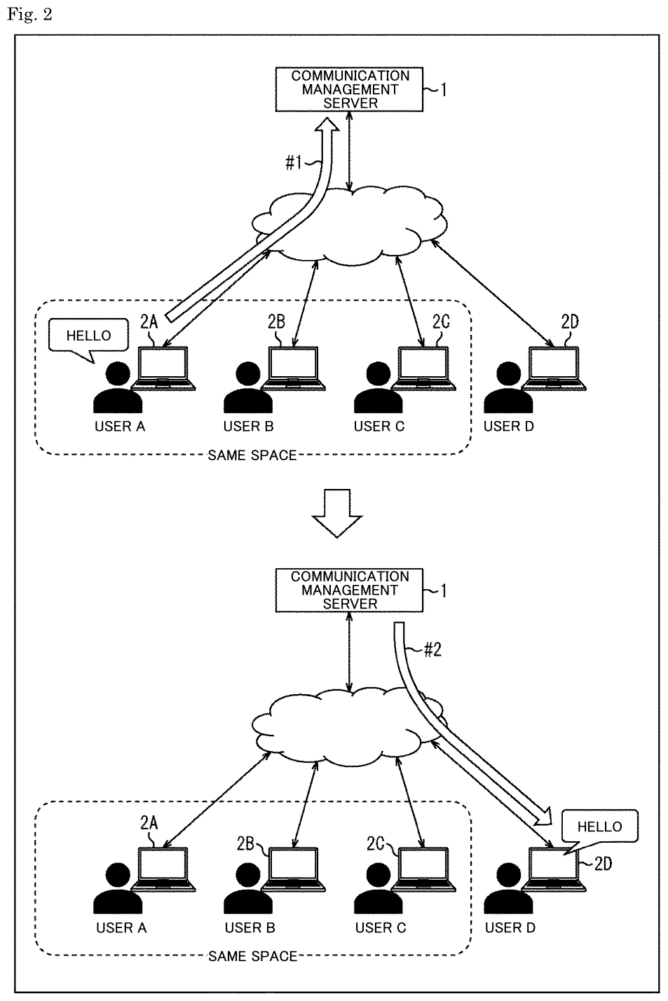

For example, when the user A speaks, the communication management server 1 receives audio data of the user A transmitted from the client terminal 2A in accordance with the user A speaking, as indicated by an arrow #1 in the upper part of FIG. 2. The audio data of the user A collected by a microphone used by the user A is transmitted from the client terminal 2A.

The communication management server 1 transmits the audio data of the user A to the client terminal 2D and causes the voice of the user A to be output, as indicated by an arrow #2 in the lower part of FIG. 2.

As a result, the users B to D can hear the voice of the user A. As described above, the earphones used by the user B and the user C are open-type earphones, and thus the user B and the user C, who are in the same space as the user A, can hear the voice of the user A directly.

Note that as will be described later, when the users A to C are wearing closed-type earphones, headphones, or the like instead of open-type earphones, the voice of the user A is also transmitted to the user B and the user C via the communication management server 1. In this case, the user B, the user C, and the user D will each hear the voice of the user A transmitted via the communication management server 1.

Similarly, when the user B or the user C speaks, audio data transmitted from the client terminal 2B or the client terminal 2C is transmitted to the client terminal 2D via the communication management server 1.

Additionally, the communication management server 1 receives audio data of the user D transmitted from the client terminal 2D in accordance with the user D speaking. The communication management server 1 transmits the audio data of the user D to each of the client terminals 2A to 2C, and causes the voice of the user D to be output. As a result, the users A to C can hear the voice of the user D.

Hereinafter, participants who actually gather in the same space with other participants and participate in a conference will be referred to as “real participants”, in the sense of being participants actually in the same space.

In the example in FIG. 1, the users A to C who participate in the conference from the conference room in the office are “real participants”. A predetermined range of space centered on a reference position is the “same space”, for example.

On the other hand, participants who participate in the conference from a space different from the space where the real participants are present will be called “remote participants”, in the sense of being participants who are in a remote location. In the example in FIG. 1, the user D, who participates in the conference alone from home, is a remote participant.

### <Voice Localization During Conference>

When outputting the audio transmitted from the communication management server 1, the client terminal 2 performs sound image localization processing. The audio transmitted from the communication management server 1 is output having been localized to a predetermined position in space.

For example, the client terminals 2 used by the users A to C perform the sound image localization processing for localizing the voice of the user D, who is a remote participant, to a predetermined position in the conference room, and cause the voice of the user D obtained by performing the sound image localization processing to be output from the earphones used by the respective users. The users A to C will experience the sound image of the voice of the user D such that the voice of the user D can be heard from the position set as a localization position.

In the communication management server 1, the localization position of the voice of the user D, who is the remote participant, is set to a predetermined position within the conference room. Information on the localization position set by the communication management server 1 is provided to the client terminal 2 and used in the sound image localization processing.

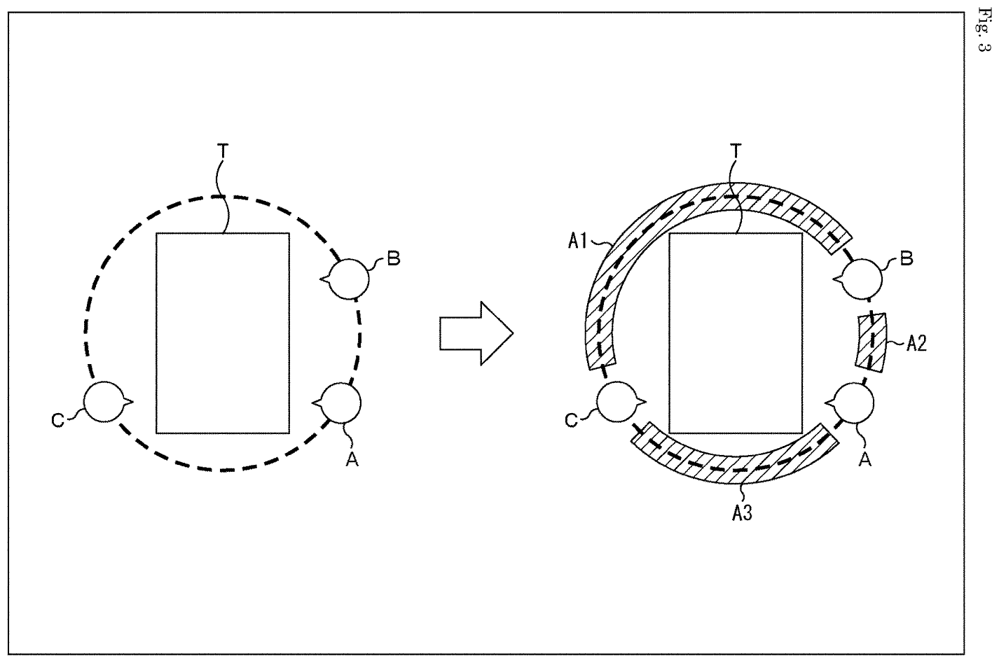

FIG. 3 is a diagram illustrating an example of setting the localization position.

The space illustrated in FIG. 3 from above is a conference room in which the users A to C are present. The user A and the user B are seated side by side on the right side of a table T provided in the conference room, and the user C is seated on the left side of the table T in a position in front of the user A.

The users A to C are sitting facing the table T. For example, when the user A speaks, the voice of the user A is naturally heard by the user B from the left, and by the user C from the front.

When the users A to C, who are real participants, are sitting in the state illustrated on the left side of FIG. 3, the communication management server 1 sets regions in which the users A to C are not present, indicated by the hatching on the right side of FIG. 3, as localizable regions, which are regions in which the voice of the user D, who is a remote participant, can be localized.

In the example on the right side of FIG. 3, the region between the user B and the user C on a circle passing through the positions of the users A to C is set as a localizable region A1. Likewise, the region between the user A and the user B is set as a localizable region A2, and the region between the user A and the user C is set as a localizable region A3. The localizable regions A1 to A3 are arc-shaped regions of a predetermined width.

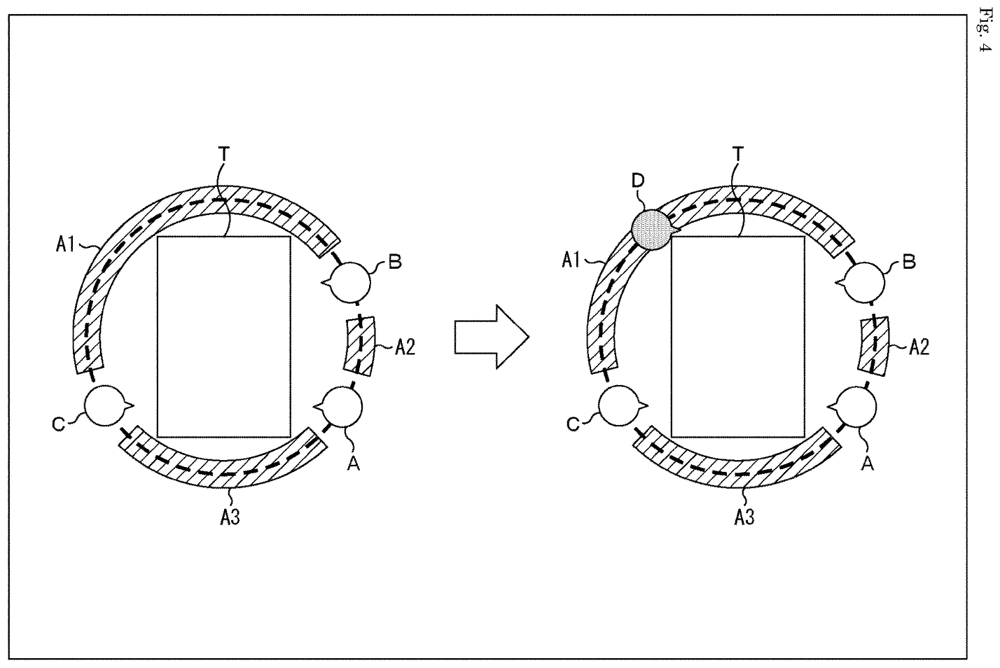

In this case, the communication management server 1 sets a predetermined position in the localizable region as the localization position of the voice of the user D, as illustrated on the right side of FIG. 4. In the example on the right side of FIG. 4, a position in the localizable region A1 is set as the localization position of the voice of the user D. The setting of the localization position of the voice of a remote participant will be described in detail later.

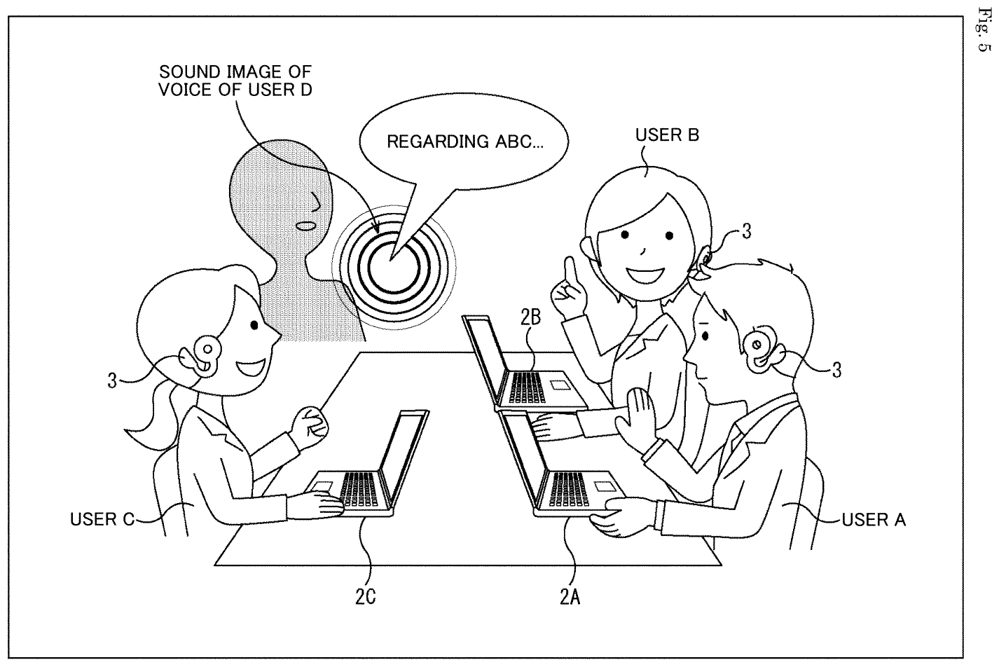

By setting the localization position of the voice of the user D in the communication management server 1 in this manner and performing the sound image localization processing in the client terminals 2, the voice of the user D is heard by the user A from a position to the right and front at an angle, and by the user B from a position from approximately directly in front, as illustrated in FIG. 5. The voice of the user D is also heard by the user C from a position approximately to the left.

In FIG. 5, the speech indicated in the callout is speech from the user D. The multiple circles at the base of the callout schematically indicate the sound image of the voice of the user D. The sound image of the voice of the user D will be experienced as being in a position where no real participant is present. Each of the users A to C is wearing earphones 3.

In this manner, taking the positions of real participants into account, the localization position of the voice of the remote participant is set to a position where no real participants are present, and thus each real participant can easily distinguish between the voices of the other real participants and the voice of the remote participant.

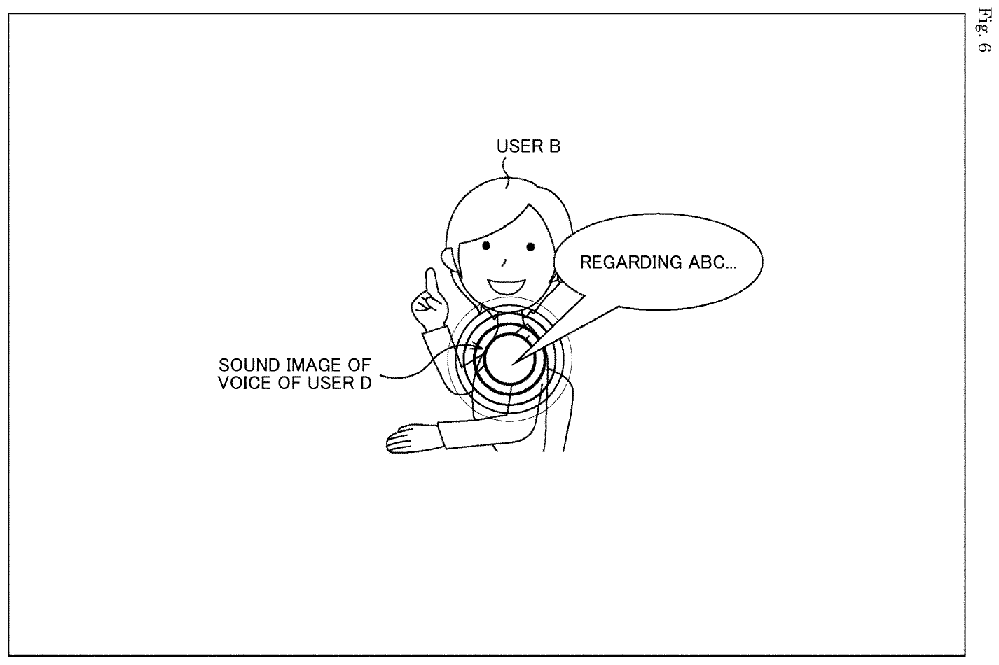

If the localization position of the voice of the remote participant is set without taking into account the positions of the real participants, the localization position of the voice of the user D, who is the remote participant, may be set to the same position as the position of the user B, who is a real participant, as illustrated in FIG. 6. In this case, the voice of the user D will be heard from the position of the user B, and the user A and the user C will be unable to determine who they are talking with, but it is possible to prevent such a state from occurring.

### <Configuration of Earphones>

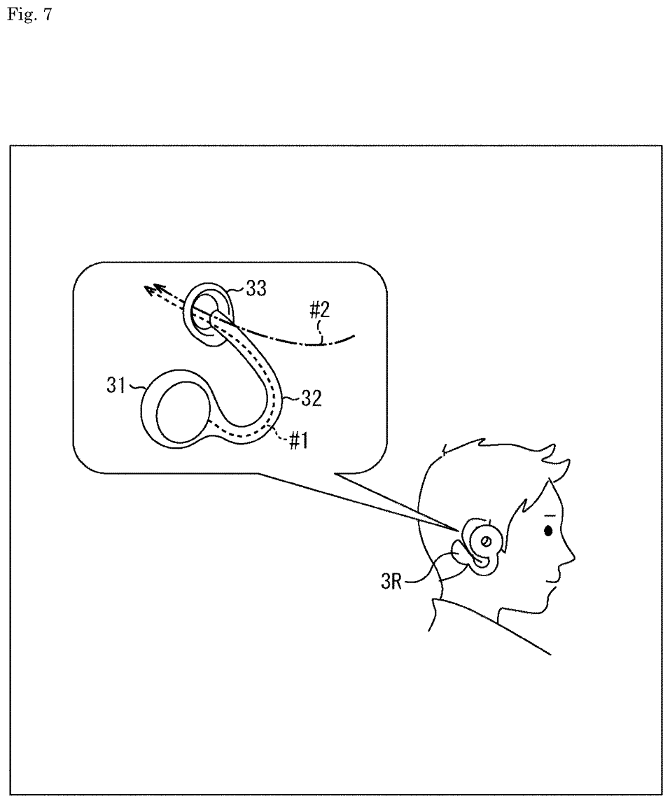

FIG. 7 is a diagram illustrating an external view of the earphones.

The earphones 3 worn by each user are constituted by a right-side unit 3R and a left-side unit 3L (not shown). As illustrated in an enlarged manner in the callout in FIG. 7, the right-side unit 3R includes a driver unit 31 and a ring-shaped mounting part 33, which are joined together by a U-shaped sound conduit 32. The right-side unit 3R is worn by pressing the mounting part 33 around the external auditory canal so that the right ear is interposed between the mounting part 33 and the driver unit 31.

The left-side unit 3L has the same structure as the right-side unit 3R. The left-side unit 3L and the right-side unit 3R are connected by a wire or wirelessly.

The driver unit 31 of the right-side unit 3R receives an audio signal transmitted from the client terminal 2 and generates sound according to the audio signal, and causes the sound to be output from the tip of the sound conduit 32 as indicated by the arrow #1. A hole is formed at the junction between the sound conduit 32 and the mounting part 33 to output sound toward the external auditory canal.

The mounting part 33 has a ring shape. Together with the audio output from the tip of the sound conduit 32, ambient sound also reaches the external auditory canal, as indicated by the arrow #2.

In this manner, the earphones 3 are what are known as open-type earphones that do not seal the ear holes. A microphone is provided in the driver unit 31, for example. A device other than the earphones 3 may be used as an output device used for listening to the voices of participants in the conference.

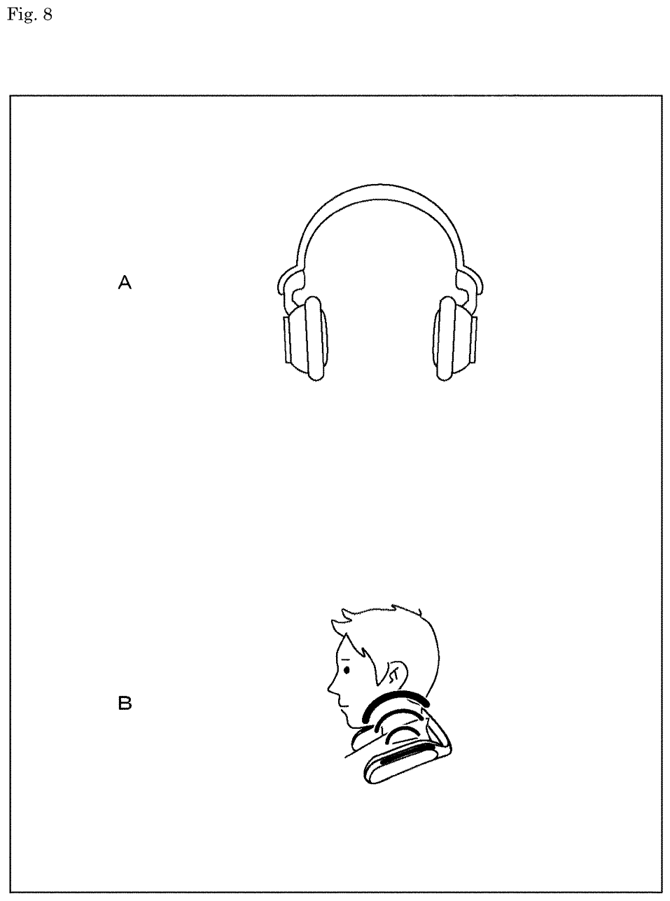

FIG. 8 is a diagram illustrating an example of an output device.

Closed-type headphones (over-ear headphones) such as those indicated by A in FIG. 8, or a shoulder-worn neckband speaker such as that indicated by B in FIG. 8, are used as output devices that can be used to listen to audio. The left and right units of neckband speakers are provided with speakers, and sound is output toward the user's ears. A microphone is provided in the headphones or the neckband speaker, and the voice of the user is collected thereby.

### <<Configurations of Devices>>

### <Configuration of Communication Management Server 1>

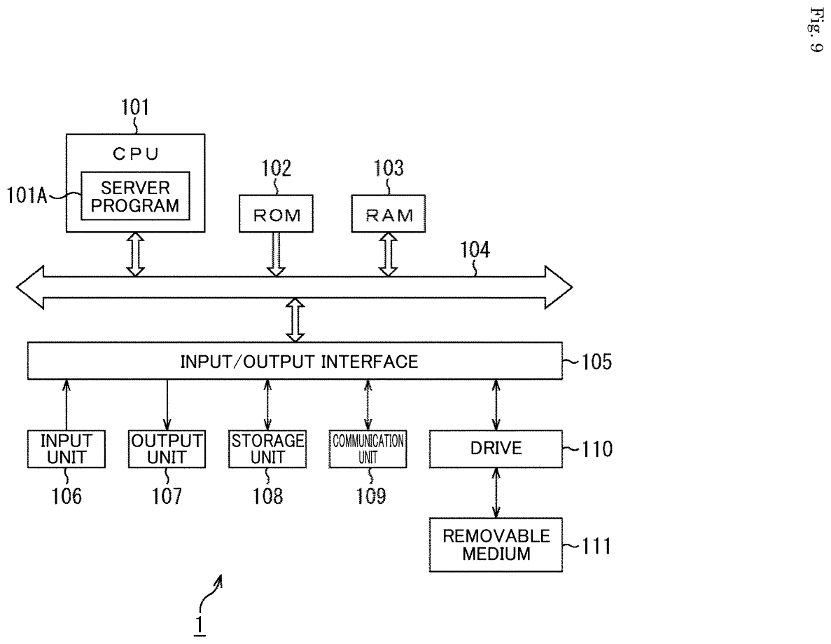

FIG. 9 is a block diagram illustrating an example of the hardware configuration of the communication management server 1.

The communication management server 1 is constituted by a computer. The communication management server 1 may be constituted by one computer having the configuration illustrated in FIG. 9, or may be constituted by a plurality of computers.

A CPU 101, a ROM 102, and a RAM 103 are connected to each other by a bus 104. The CPU 101 controls the overall operations of the communication management server 1 by executing a server program 101A. The server program 101A is a program for realizing a tele-communication system.

An input/output interface 105 is further connected to the bus 104. An input unit 106 constituted by a keyboard, a mouse, and the like and an output unit 107 constituted by a display, a speaker, and the like are connected to the input/output interface 105.

In addition, a storage unit 108 constituted by a hard disk, a non-volatile memory, or the like, a communication unit 109 constituted by a network interface or the like, and a drive 110 that drives a removable medium 111 are connected to the input/output interface 105. For example, the communication unit 109 communicates with the client terminals 2 used by the respective users over the network 11.

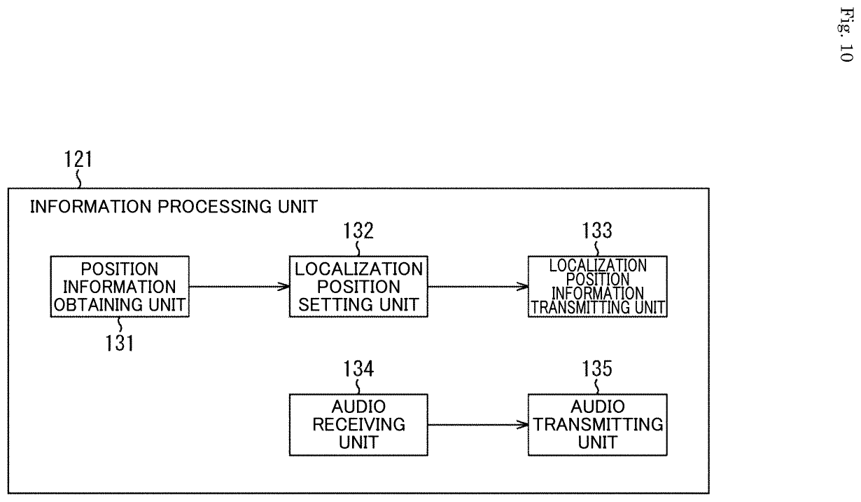

FIG. 10 is a block diagram illustrating an example of the functional configuration of the communication management server 1. At least some of the functional units illustrated in FIG. 10 are implemented by the server program 101A being executed by the CPU 101 illustrated in FIG. 9.

An information processing unit 121 is implemented in the communication management server 1. The information processing unit 121 is constituted by a position information obtaining unit 131, a localization position setting unit 132, a localization position information transmitting unit 133, an audio receiving unit 134, and an audio transmitting unit 135.

The position information obtaining unit 131 obtains the position of the real participant. Position information expressing the position of the real participant is transmitted from the client terminal 2 used by the real participant. If there are a plurality of real participants, the position of each real participant is obtained based on the position information transmitted from the corresponding client terminal 2. The position information obtained by the position information obtaining unit 131 is supplied to the localization position setting unit 132.

The localization position setting unit 132 sets the localizable region to a position where there no real participant is present, that is, at a position different from the position of the real participant, based on the position of the real participant in the same space. The localization position setting unit 132 also sets a predetermined position within the localizable region as the localization position of the voice of the remote participant. Localization position information, which is information on the localization position of the voice of the remote participant set by the localization position setting unit 132, is supplied to the localization position information transmitting unit 133 along with the position information of the real participant.

The localization position information transmitting unit 133 controls the communication unit 109 to transmit the localization position information supplied from the localization position setting unit 132 to the client terminal 2 used by each real participant.

The localization position information transmitting unit 133 also transmits the localization position information and the position information of the real participant to the client terminal 2 used by each remote participant. For example, in the client terminal 2 used by the remote participant, sound image localization processing is performed such that the voice of each real participant is heard from a direction based on the position of that real participant, taking the position of the remote participant expressed by the localization position information as a reference.

The audio receiving unit 134 controls the communication unit 109 to receive the audio data transmitted from the client terminal 2 used by the participant who has spoken. The audio data received by the audio receiving unit 134 is output to the audio transmitting unit 135.

The audio transmitting unit 135 controls the communication unit 109 to transmit the audio data supplied from the audio receiving unit 134 to the client terminal 2 used by the participant who will serve as the listener.

### <Configuration of Client Terminal 2>

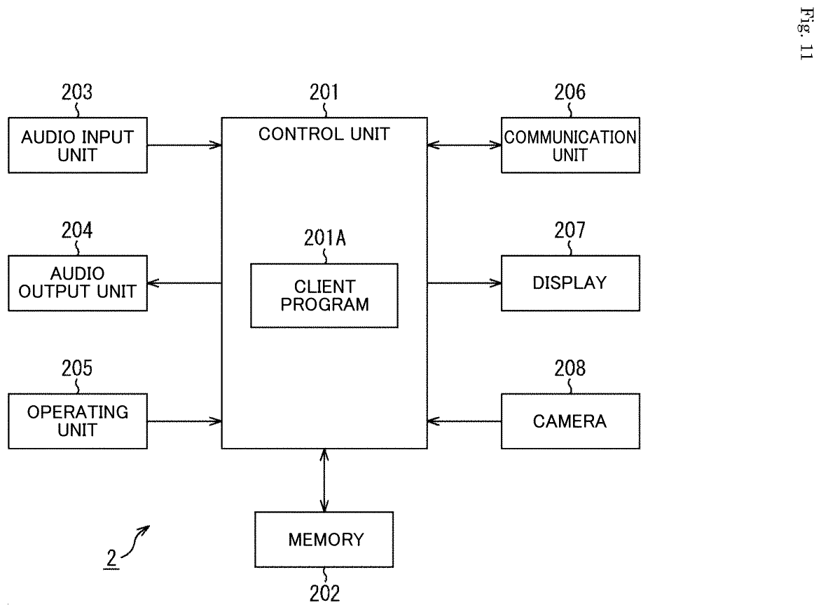

FIG. 11 is a block diagram illustrating an example of the hardware configuration example of the client terminal 2.

The client terminal 2 is configured by a memory 202, an audio input unit 203, an audio output unit 204, an operating unit 205, a communication unit 206, a display 207, and a camera 208 being connected to a control unit 201.

The control unit 201 is constituted by a CPU, a ROM, a RAM, and the like. The control unit 201 controls the overall operations of the client terminal 2 by executing a client program 201A. The client program 201A is a program for using the tele-communication system managed by the communication management server 1.

For example, the client terminal 2 is realized by installing the client program 201A, which is a dedicated application program, on a general-purpose PC. The client terminal 2 may be realized by installing a DSP board and an A/D/A conversion board in a general-purpose PC, or may be implemented by a dedicated device.

The memory 202 is constituted by flash memory or the like. The memory 202 stores various types of information such as the client program 201A executed by the control unit 201.

The audio input unit 203 communicates with the earphones 3 and receives the audio transmitted from the earphones 3. The voice of the user collected by the microphone provided in the earphones 3 is transmitted from the earphones 3. The audio received by the audio input unit 203 is output to the control unit 201 as microphone audio.

Audio may be input using the microphone provided in the client terminal 2, or using an external microphone connected to the client terminal 2.

The audio output unit 204 communicates with the earphones 3 and transmits an audio signal supplied from the control unit 201, which causes the voices of the participants in the conference to be output from the earphones 3.

The operating unit 205 is constituted by an input unit such as a keyboard, or a touch panel provided on top of the display 207. The operating unit 205 outputs information expressing the content of the user's operations to the control unit 201.

The communication unit 206 is a communication module that supports wireless communication for a mobile communication system such as 5G communication, a communication module that supports wireless LAN, or the like. The communication unit 206 communicates with the communication management server 1 over the network 11, which is an IP communication network. The communication unit 206 receives information transmitted from the communication management server 1 and outputs the information to the control unit 201. The communication unit 206 also transmits information supplied from the control unit 201 to the communication management server 1.

The display 207 is constituted by an organic EL display, an LCD, or the like. The display 207 displays various screens such as a screen of a remote conference.

The camera 208 is constituted by an RGB camera, for example. The camera 208 shoots the user, who is a participant in the conference, and outputs the resulting image to the control unit 201. In addition to audio, images shot by the camera 208 are transmitted and received among the respective client terminals 2 via the communication management server 1 as appropriate.

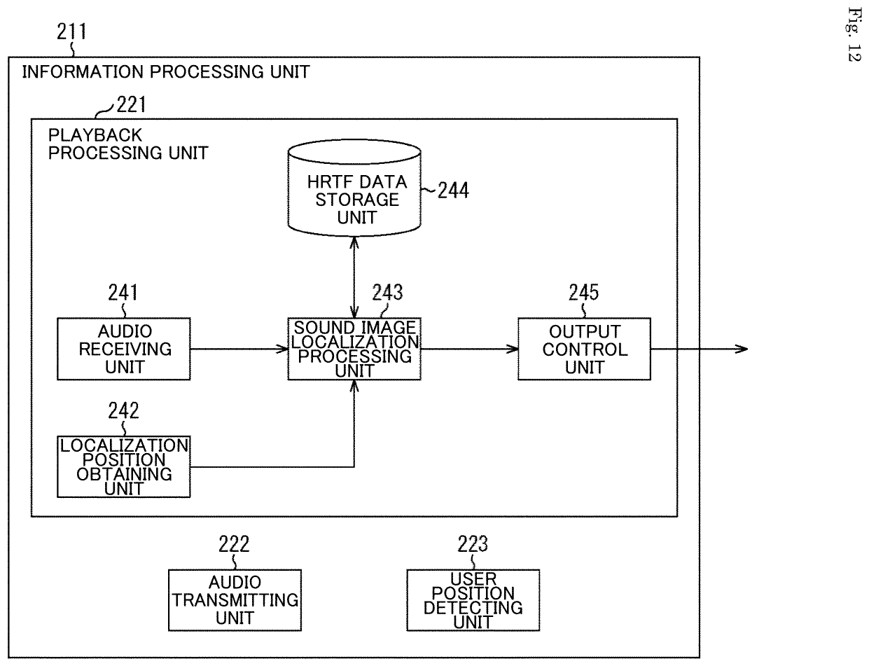

FIG. 12 is a block diagram illustrating an example of the functional configuration of the client terminal 2. At least some of the functional units illustrated in FIG. 12 are implemented by the client program 201A being executed by the control unit 201 illustrated in FIG. 11.

An information processing unit 211 is implemented in the client terminal 2. The information processing unit 211 is constituted by a playback processing unit 221, an audio transmitting unit 222, and a user position detecting unit 223. The information processing unit 211 in FIG. 12 is mainly described as being a configuration in the client terminal 2 used by a real participant.

The playback processing unit 221 is constituted by an audio receiving unit 241, a localization position obtaining unit 242, a sound image localization processing unit 243, an HRTF data storage unit 244, and an output control unit 245.

The audio receiving unit 241 controls the communication unit 206 and receives the audio data transmitted from the communication management server 1. The communication management server 1 transmits the audio data of other participants, such as a remote participant. The audio data received by the audio receiving unit 241 is output to the sound image localization processing unit 243.

The localization position obtaining unit 242 controls the communication unit 206 and receives the localization position information transmitted from the communication management server 1. The communication management server 1 transmits the localization position information expressing the localization position of the voice of the remote participant. The localization position information received by the localization position obtaining unit 242 is supplied to the sound image localization processing unit 243.

The sound image localization processing unit 243 reads out and obtains HRTF (Head-Related Transfer Function) data from the HRTF data storage unit 244 in accordance with positional relationships (direction-distance relationships) between the positions of the users of the client terminals 2 who are real participants and the localization position of the voice of the remote participant expressed by the localization position information.

The HRTF data storage unit 244 stores HRTF data, which is HRTF (Head-Related Transfer Function) data which, when each position in the space in which the real participants are present is taken as a listening position, expresses the transmission characteristics of sounds from various positions to the listening position. HRTF data corresponding to a plurality of positions is prepared in the client terminal 2, taking each listening position in the space where the real participants are present as a reference.

The sound image localization processing unit 243 performs sound image localization processing using the HRTF data on the audio data of the remote participant such that the voice of the remote participant who has spoken is heard from the localization position of the voice of the remote participant. The sound image localization processing performed by the sound image localization processing unit 243 includes rendering such as VBAP (Vector Based Amplitude Panning) based on position information, and binaural processing using the HRTF data.

In other words, the voice of the remote participant is processed at the client terminal 2 as audio data of object audio. Channel-based audio data for two channels, i.e., L/R, for example, which is generated through the sound image localization processing, is supplied to the output control unit 245.

The output control unit 245 outputs the audio data generated by the sound image localization processing to the audio output unit 204 and causes the audio data to be output from the earphones 3.

The audio transmitting unit 222 controls the communication unit 206 and transmits data of the microphone audio, supplied from the audio input unit 203, to the communication management server 1.

The user position detecting unit 223 detects the position of the user of the client terminal 2 who is a real participant. The user position detecting unit 223 functions as a position sensor for conference participants.

The position of the user of the client terminal 2 is detected based on information of a positioning system such as GPS, for example. The position of the user is also detected based on information on a mobile base station and information on a wireless LAN access point. The position of the user may be detected using Bluetooth (registered trademark) communication, or the position of the user may be detected based on the image shot by the camera 208. The position of the user may be detected based on a measurement result from an accelerometer or a gyrosensor installed in the client terminal 2.

The user position detecting unit 223 controls the communication unit 206 and transmits the position information, expressing the position of the user of the client terminal 2, to the communication management server 1.

Note that when the information processing unit 211 illustrated in FIG. 12 is configured to be provided in the client terminal 2 used by the remote participant, the audio receiving unit 241 receives the audio data of the real participants and other remote participants, transmitted from the communication management server 1.

In the localization position obtaining unit 242, the localization position information transmitted from the communication management server 1 and the position information of the real participants are received, and the sound image localization processing is performed in the sound image localization processing unit 243 using the HRTF data corresponding to the respective positional relationships among the real participants and the other remote participants. The voice of the real participants and the voice of the other remote participants obtained by performing the sound image localization processing is caused by the output control unit 245 to be output from the earphones 3 used by the user of the client terminal 2 who is the remote participant.

Note that rendering of the audio data may be performed using computing functions provided in external apparatuses, such as mobile phones, PHS, VoIP phones, digital exchanges, gateways, terminal adapters, and the like.

### <<Operations of Tele-Communication System>>

<Processing before Start of Conference>

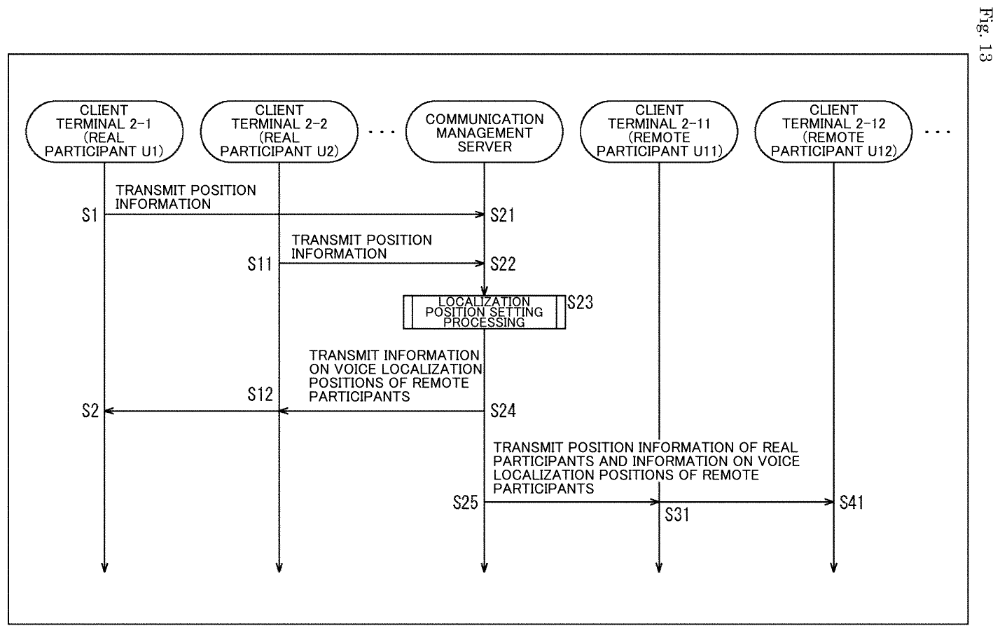

Overall processing performed before starting a conference will be described with reference to the flowchart in FIG. 13.

FIG. 13 illustrates processing by the client terminals 2 used by real participants U1 and U2 and processing by the client terminals 2 used by remote participants U11 and U12 as the processing by the client terminals 2. The same applies to the other sequence charts described later as well.

The client terminal 2 used by the real participant U1 will be described as a client terminal 2-1, and the client terminal 2 used by the real participant U2 will be described as a client terminal 2-2. Similarly, the client terminal 2 used by the remote participant U11 will be described as a client terminal 2-11, and the client terminal 2 used by the remote participant U12 will be described as a client terminal 2-12.

The processing by the client terminals 2 used by other real participants participating in the same conference is the same as the processing by the client terminals 2-1 and 2-2 used by the real participants U1 and U2. Additionally, the processing by the client terminals 2 used by other remote participants participating in the same conference is the same as the processing by the client terminals 2-11 and 2-12 used by the remote participants U11 and U12.

In step S1, the user position detecting unit 223 of the client terminal 2-1 detects the position of the real participant U1 and transmits the position information to the communication management server 1.

In step S11, the user position detecting unit 223 of the client terminal 2-2 detects the position of the real participant U2 and transmits the position information to the communication management server 1.

In step S21, the position information obtaining unit 131 of the communication management server 1 receives the position information transmitted from the client terminal 2-1 and obtains the position of the real participant U1.

In step S22, the position information obtaining unit 131 receives the position information transmitted from the client terminal 2-2 and obtains the position of the real participant U2.

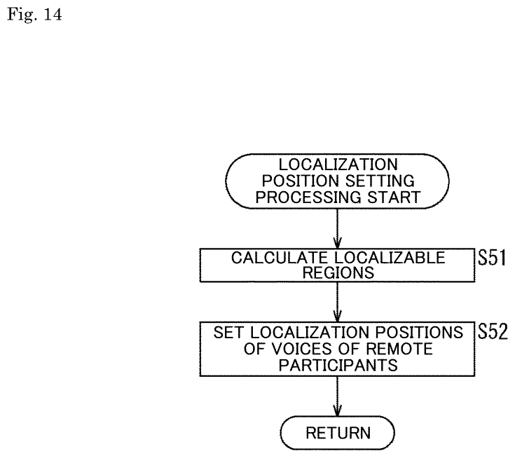

In step S23, the localization position setting unit 132 performs the localization position setting processing. The localization positions of the voices of the remote participants U11 and U12 are set through the localization position setting processing. The localization position setting processing will be described in detail later with reference to the flowchart illustrated in FIG. 14.

In step S24, the localization position information transmitting unit 133 transmits, to the client terminal 2-1 and the client terminal 2-2, the localization position information expressing the localization positions of the respective voices of the remote participants U11 and U12.

In step S25, the localization position information transmitting unit 133 transmits, to the client terminal 2-11 and the client terminal 2-12, the localization position information expressing the localization positions of the respective voices of the remote participants U11 and U12, along with the position information expressing the respective positions of the real participants U1 and U2.

In step S2, the localization position obtaining unit 242 of the client terminal 2-1 receives the localization position information transmitted from the communication management server 1.

In step S12, the localization position obtaining unit 242 of the client terminal 2-2 receives the localization position information transmitted from the communication management server 1.

In step S31, the localization position obtaining unit 242 of the client terminal 2-11 receives the position information of the respective real participants U1 and U2 and the localization position information of the remote participant U12, transmitted from the communication management server 1.

In step S41, the localization position obtaining unit 242 of the client terminal 2-12 receives the position information of the respective real participants U1 and U2 and the localization position information of the remote participant U11, transmitted from the communication management server 1.

The localization position setting processing performed in step S23 of FIG. 13 will be described with reference to the flowchart in FIG. 14.

In step S51, the localization position setting unit 132 of the communication management server 1 calculates the localizable region based on the positions of the real participants obtained by the position information obtaining unit 131.

In step S52, the localization position setting unit 132 also sets a predetermined position within the localizable region as the localization position of the voice of the remote participant. The sequence then returns to step S23 of FIG. 13, and the processing following thereafter is performed.

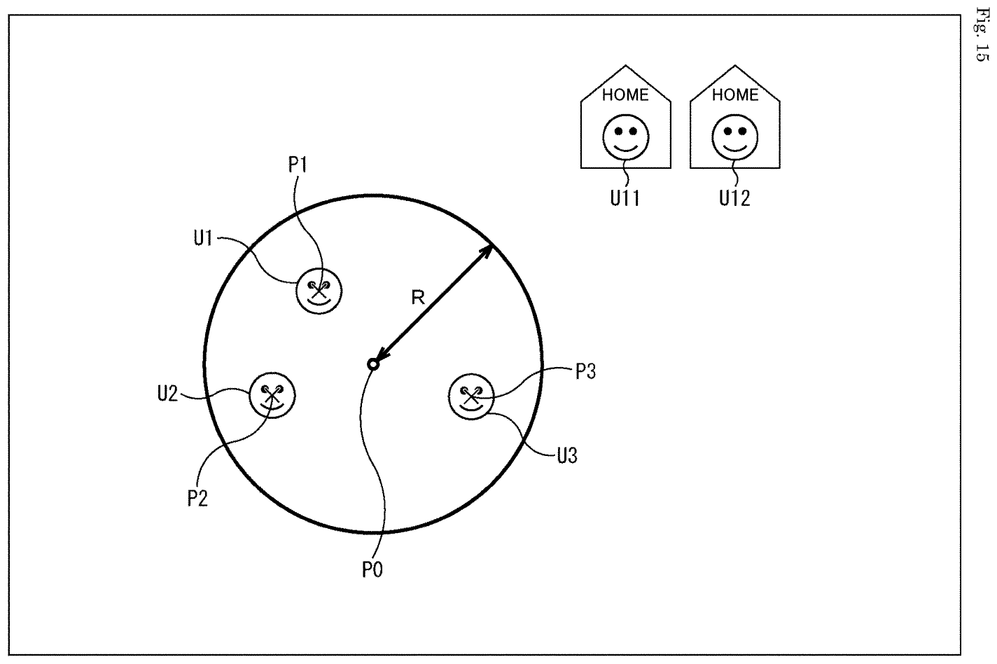

The flow of setting the localization position for the voice of the remote participants will be described with reference to FIGS. 15 to 20.

As illustrated in FIG. 15, it is assumed that real participants U1 to U3 are in positions P1 to P3, respectively, in the same space, such as a conference room. The positions P1 to P3 are specified based on the position information transmitted from the client terminals 2 used by the real participants U1 to U3, respectively.

The localization position setting unit 132 creates a circle of a predetermined radius R [m] in the space where the real participants are present, and forms a group constituted by the real participants who are inside the created circle as a single group of participants in the same conference.

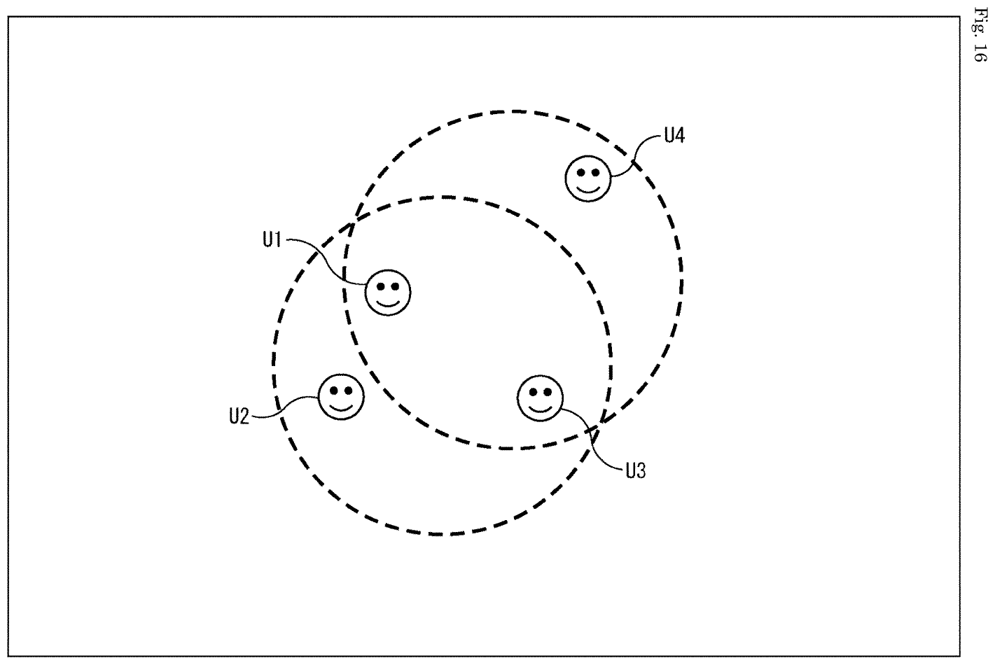

As illustrated in FIG. 16, when there are multiple ways of forming the group, the localization position setting unit 132 makes a notification to the participants to approach each other by outputting voice from the client terminals 2, such as “conference room participants, please gather together”. As indicated by the broken line circles, in the example in FIG. 16, one group is formed by the real participants U1 to U3, and one group is formed by real participants U1, U3, and U4.

This processing continues until a single group is formed. For example, a circle having a radius of 5 m is set as a circle that forms the group.

Depending on the size of the space, the sizes of the circle used to form a group may be changed, for example, by the real participants themselves.

If x coordinates and y coordinates of positions P1 to PN of real participants U1 to UN forming the same group are taken as (x1, y1) to (xn, yn) (where n=1 to N), the localization position setting unit 132 obtains xc, yc, and r1 where the sum of distances to the points (xn, yn) is the smallest in the circle expressed by the following Formula (1).

[Math. 1]

(xₙ−x_{c})²+(yₙ−y_{c})²=r₁² (1)

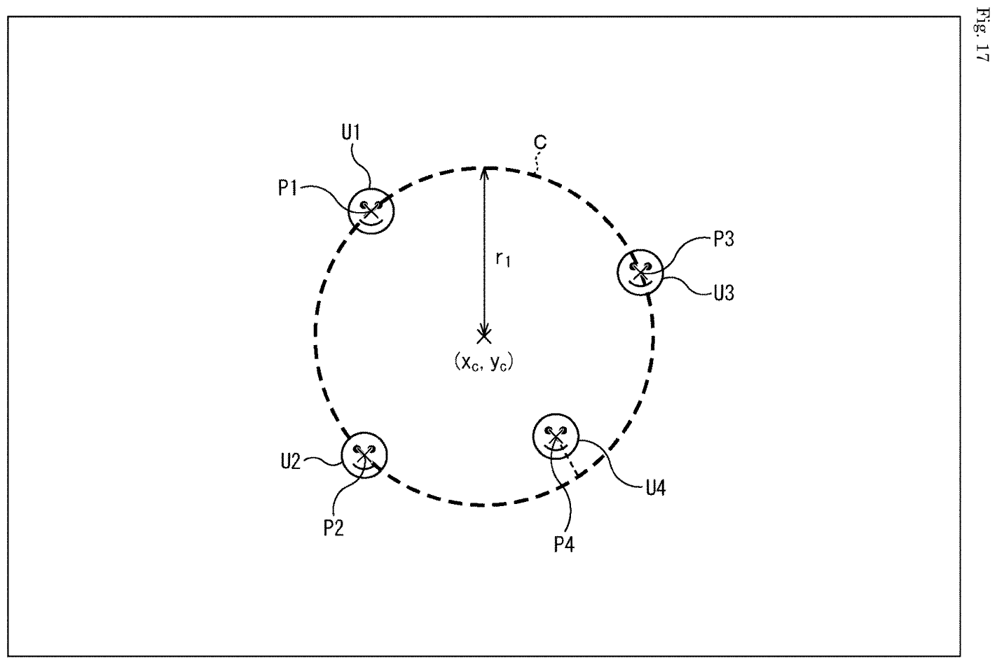

Obtaining xc, yc, and r1 is equivalent to obtaining an approximate circle of a point group at positions P1 to PN, as indicated by the broken line circle in FIG. 17. In the example in FIG. 17, an approximate circle C having a radius r1 is set according to the positions P1 to P4 where the real participants U1 to U4 are present. When N=2, a circle having passing through the position P1 and the position P2 at a minimum radius is set as the approximate circle.

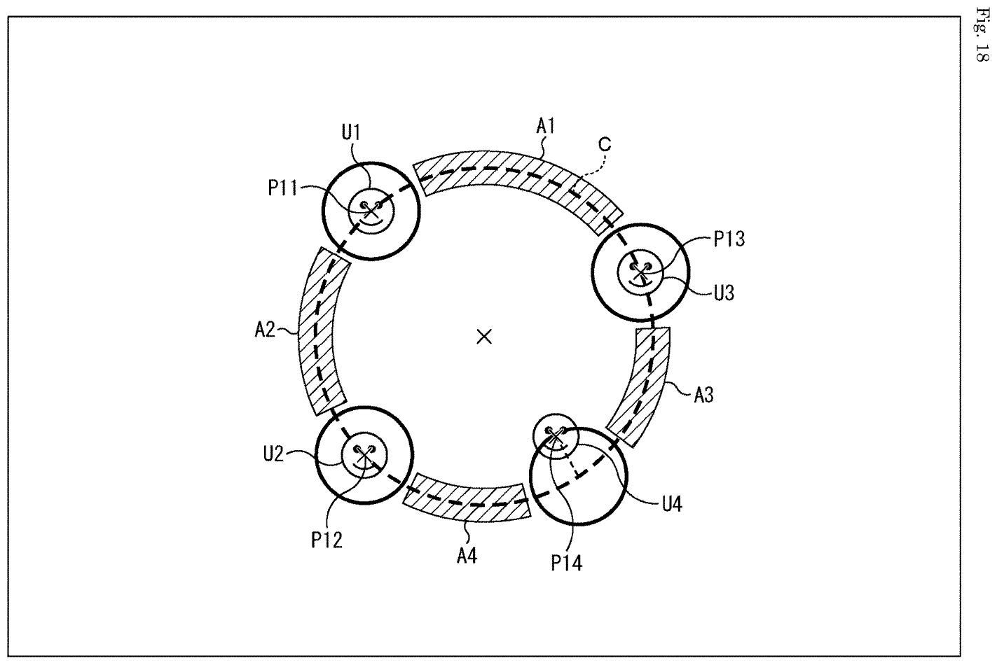

As indicated by the hatching in FIG. 18, the localization position setting unit 132 sets the localizable regions at positions on the approximate circle C that are distanced from the positions at which the real participants are actually present. The localizable regions are arc-shaped regions of a predetermined width, as described above. For example, the localizable regions are set to positions r2 [m] or more from the positions on the approximate circle C nearest to the positions where the real participants are actually present.

In the example in FIG. 18, the localizable region A1 is set between the real participant U1 and the real participant U3 at a predetermined distance from each real participant, and the localizable region A2 is set between the real participant U1 and the real participant U2 at a predetermined distance from each real participant. In addition, the localizable region A3 is set between the real participant U3 and the real participant U4 at a predetermined distance from each real participant, and a localizable region A4 is set between the real participant U2 and the real participant U4 at a predetermined distance from each real participant.

The solid line small circles surrounding the real participants U1 to U3 are circles having a radius r2 centered on the position of the corresponding real participant on the approximate circle C. The solid line small circle near the real participant U4 is a circle having a radius r2 centered on a position on the approximate circle C.

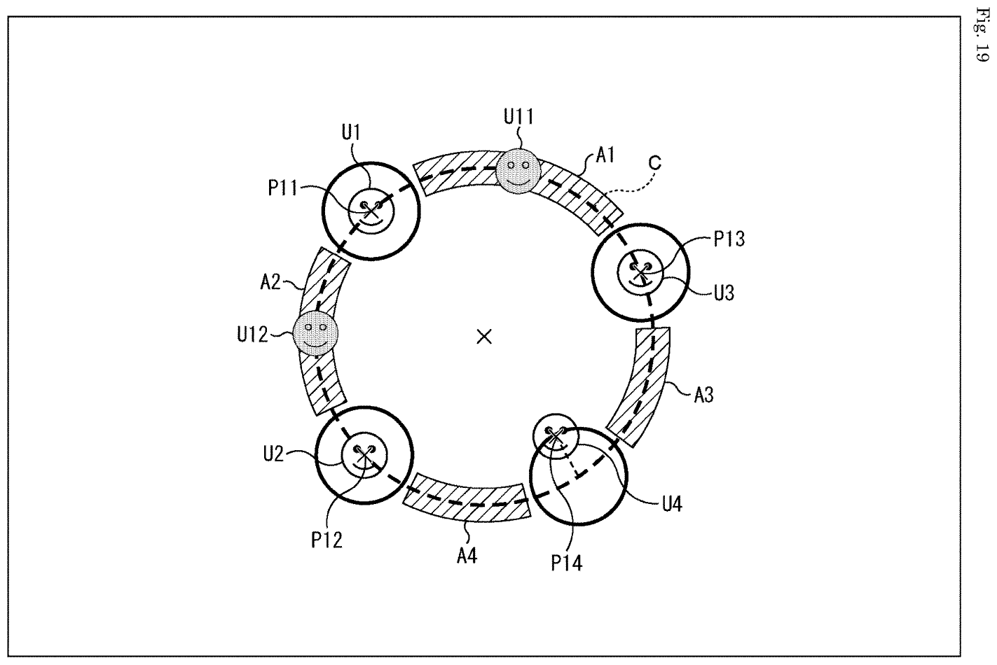

After the localizable region is set, the localization position setting unit 132 sets the localization position of the voice of the remote participant within the localizable region. In the example in FIG. 19, the localization position of the voice of the remote participant U11, who is the first remote participant, is set approximately in the center of the localizable region A1, and the localization position of the voice of the remote participant U12, who is the second remote participant, is set approximately in the center of the localizable region A2.

When positions of voices are close, it is difficult to distinguish between them. For example, the localization positions of the voice of the remote participants are set such that the angles from a center O of the approximate circle C are dispersed.

In other words, assuming the positions P1 to PN at which the real participants are actually present and localization positions Qm of the voices of M remote participants (where m=1 to M), the localization positions Qm are set such that the minimum values of an angle PiOPj (1≤i<j≤N), an angle QiOQj (1≤i<j≤M), and an angle PiOQJ (1≤i≤N, 1≤j≤M) are the highest. By separating the localization positions Qm as far as possible from the positions of the real participants (dispersing the angles), the voices can be made easier to distinguish.

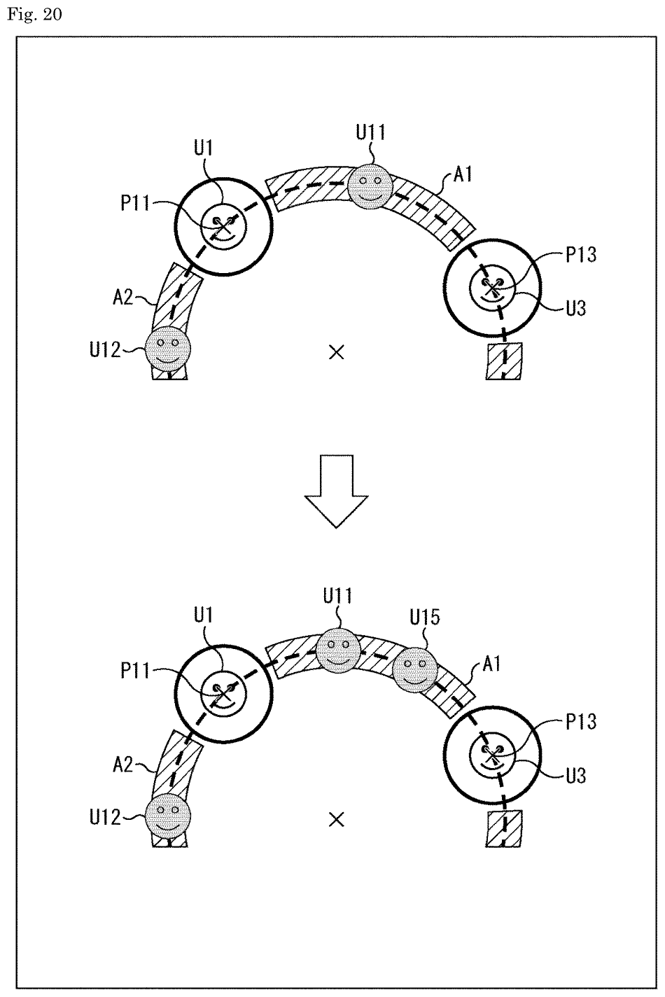

When setting the localization positions of the voices of the two remote participants in one localizable region, the localization positions of the voices of the remote participants are adjusted such that those positions are distanced from each other. For example, in the example in FIG. 20, a remote participant U15 joins the conference after the localization position of the voice of the remote participant U11 has been set within the localizable region A1, and the localization positions of the voices of the remote participant U11 and the remote participant U15 are adjusted such that the positions are distanced from each other.

After the localization positions of the voices of the remote participants are set in this manner, the transmission and reception of audio is started.

<Processing after Start of Conference>

When Remote Participant Speaks

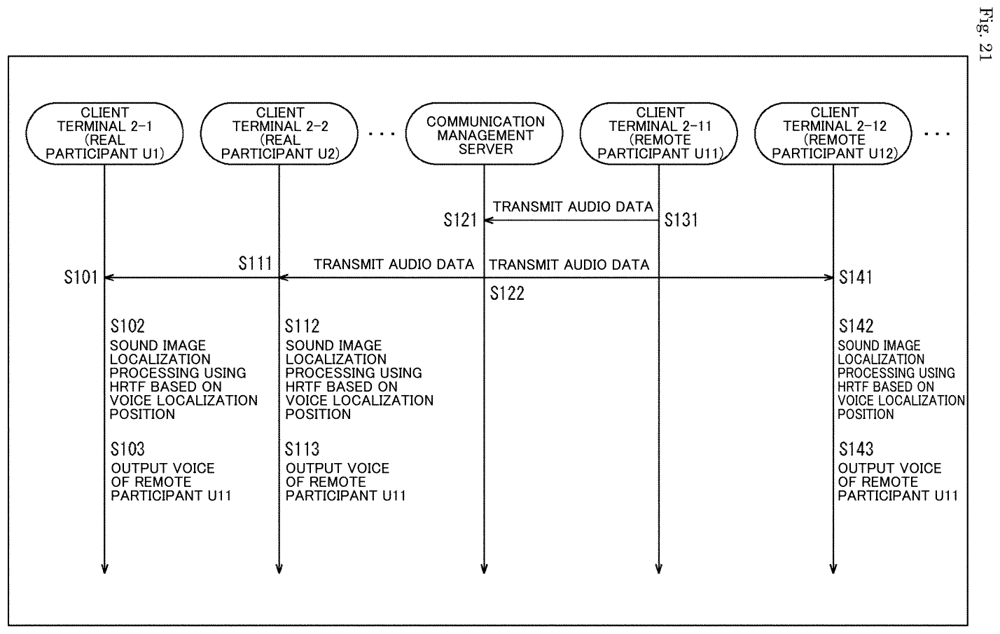

Overall processing performed after starting a conference will be described with reference to the flowchart in FIG. 21. The processing illustrated in FIG. 21 is processing performed in response to a remote participant speaking.

For example, when the remote participant U11 has spoken, in step S131, the audio transmitting unit 222 of the client terminal 2-11 (FIG. 12) transmits the audio data of the remote participant U11 to the communication management server 1.

In step S121, the audio receiving unit 134 of the communication management server 1 (FIG. 10) receives the audio data transmitted from the client terminal 2-11.

In step S122, the audio transmitting unit 135 transmits the audio data of the remote participant U11 to each of the client terminals 2-1, 2-2, and 2-12.

In step S101, the audio receiving unit 241 of the client terminal 2-1 receives the audio data transmitted from the communication management server 1.

In step S102, the sound image localization processing unit 243 performs sound image localization processing using the HRTF data on the audio data of the remote participant U11 such that the voice is heard from the localization position of the voice of the remote participant U11 who has spoken.

In step S103, the output control unit 245 causes the voice of the remote participant U11 generated by the sound image localization processing to be output from the earphones 3 worn by the real participant U1.

The client terminal 2-2 causes the voice of the remote participant U11 to be output from the earphones 3 worn by the real participant U2 by performing the same processing as the processing of steps S101 to S103 in steps S111 to S113.

Similarly, the client terminal 2-12 causes the voice of the remote participant U11 to be output from the earphones 3 worn by the remote participant U12 by performing the same processing as the processing of steps S101 to S103 in steps S141 to S143.

This enables the real participants U1 and U2, who are real participants, and the remote participant U12, who is the other remote participant, to hear the voice of the remote participant U11. Because the voice of the remote participant U11 is experienced as being localized at a position distant from the real participants U1 and U2, the real participants U1 and U2 and the remote participant U12 can distinguish between the voice of the remote participant U11 and the voices of the other participants.

When Real Participant Speaks—1

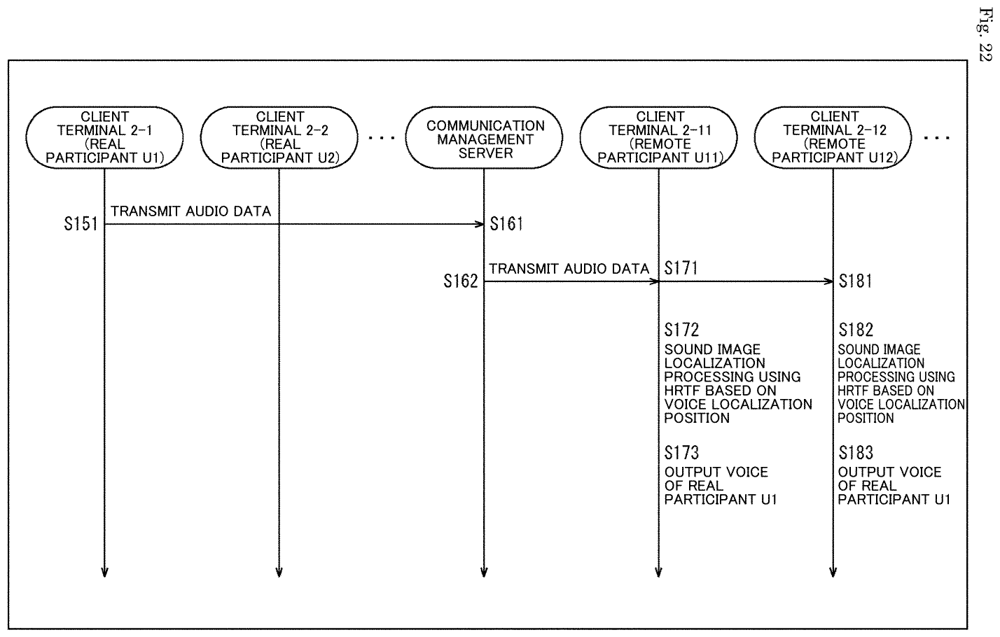

Other overall processing performed after starting a conference will be described with reference to the flowchart in FIG. 22. The processing illustrated in FIG. 22 is processing performed in response to a real participant speaking.

For example, when the real participant U1 has spoken, in step S151, the audio transmitting unit 222 of the client terminal 2-1 transmits the audio data of the real participant U1 to the communication management server 1.

In step S161, the audio receiving unit 134 of the communication management server 1 receives the audio data transmitted from the client terminal 2-1.

In step S162, the audio transmitting unit 135 transmits the audio data of the real participant U1 to each of the client terminals 2-11 and 2-12.

In step S171, the audio receiving unit 241 of the client terminal 2-11 receives the audio data transmitted from the communication management server 1.

In step S172, the sound image localization processing unit 243 performs sound image localization processing using the HRTF data on the audio data of the real participant U1 such that the voice is heard from the position of the real participant U1 who has spoken.

In step S173, the output control unit 245 causes the voice of the real participant U1 generated by the sound image localization processing to be output from the earphones 3 worn by the remote participant U11.

The client terminal 2-12 causes the voice of the real participant U1 to be output from the earphones 3 worn by the remote participant U12 by performing the same processing as the processing of steps S171 to S173 in steps S181 to S183.

This enables the remote participants U11 and U12, who are remote participants, to hear the voice of the real participant U1.

When Real Participant Speaks—2

As described above, when a real participant is wearing closed-type headphones or the like, for example, the voices of other real participants who speak are delivered via the communication management server 1 rather than directly. For example, in the client terminals 2 used by real participants wearing closed-type headphones, sound image localization processing is performed on the voices of other real participants.

Note that even when a real participant is wearing open-type earphones 3, the voices of the other real participants may be delivered via the communication management server 1 and subjected to the sound image localization processing.

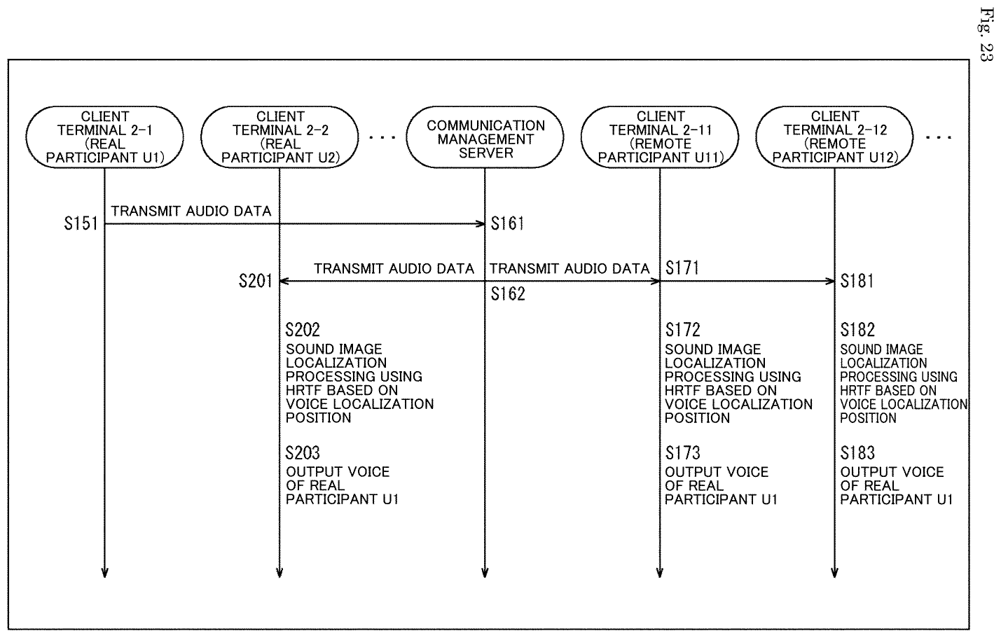

Other overall processing performed after starting a conference will be described with reference to the flowchart in FIG. 23. The processing illustrated in FIG. 23 is processing performed in response to the real participant U1 speaking. The real participant U2 is assumed to be wearing closed-type headphones.

The processing illustrated in FIG. 23 differs from the processing illustrated in FIG. 22 in that the sound image localization processing for the audio data transmitted from the communication management server 1 is performed in the client terminal 2-2. Redundant descriptions will be omitted as appropriate.

The audio data of the real participant U1 transmitted from the communication management server 1 in step S162 is also transmitted to the client terminal 2-2.

In step S201, the audio receiving unit 241 of the client terminal 2-2 receives the audio data transmitted from the communication management server 1.

In step S202, the sound image localization processing unit 243 performs sound image localization processing using the HRTF data on the audio data of the real participant U1 such that the voice is heard from the position of the real participant U1 who has spoken.

In step S203, the output control unit 245 causes the voice of the real participant U1 generated by the sound image localization processing to be output from the earphones 3 worn by the real participant U2.

As described thus far, by presenting the voice of remote participants so as to be heard from positions shifted from real participants based on position information of the conference participants, each participant can hear the voices of the remote participants from positions where the real participants are not present, which makes it possible to distinguish the voices from each other easily.

Additionally, by calculating regions in which the voices of the remote participants can be presented based on the position information of the conference participants, and distributing the localization positions of the voices throughout the localizable regions, each participant can easily distinguish between the voices.

### <<Variations>>

### <Setting Exclusion Region>

If a region that should not be used as a localization position of the voice of a remote participant is present in a space such as a conference room, the localizable regions are set to exclude such a region, and the localization positions of the voices of the remote participants are then set. In other words, a region that should not be used as a localization position of the voices of the remote participants is set as an exclusion region.

For example, when the shape and size of the conference room in which real participants are present are known, the localizable regions are set in the communication management server 1 such that regions outside the conference room, regions where walls are present, and the like are excluded.

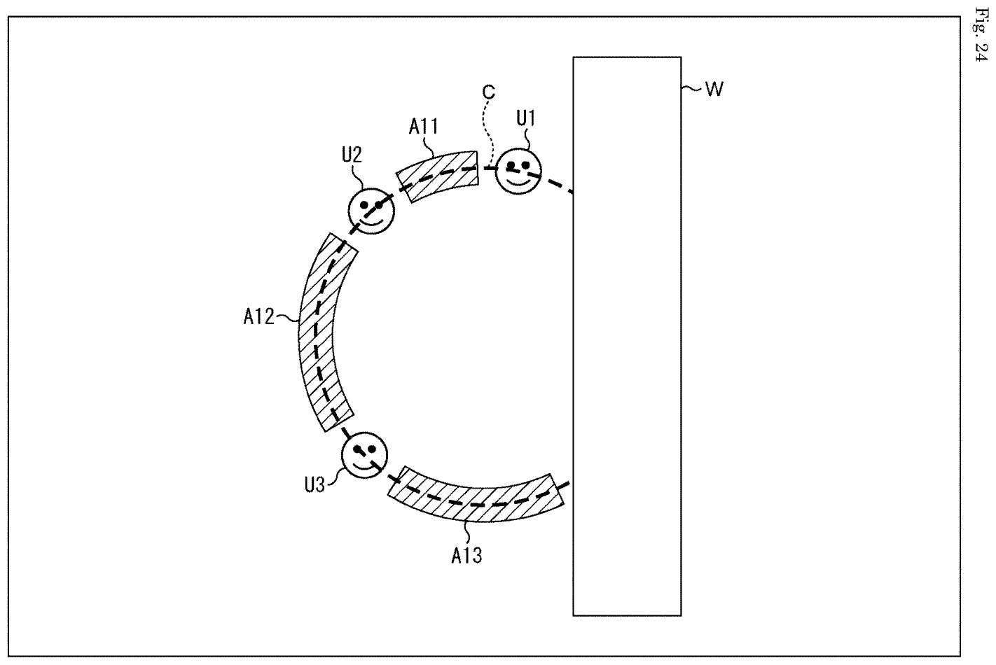

FIG. 24 is a diagram illustrating an example of setting localizable regions.

As illustrated in FIG. 24, if a wall W of the conference room overlaps with the approximate circle C set in accordance with the positions of the real participants, the localizable regions are set to exclude the region to the right of the surface of the wall W. The environment, such as the position of the wall W, is detected by the user position detecting unit 223 of the client terminals 2 along with the positions of the real participants, and is provided to the communication management server 1. For example, the environment in which the real participants are present is detected by the user position detecting unit 223 based on an image shot by the camera 208.

In the example in FIG. 24, localizable regions A11, A12, and A13 are set between the real participant U1 and the real participant U2 who are close to the wall W, between the real participant U2 and the real participant U3, and between the real participant U3 and the wall W, respectively. No localizable region is set in the region, on the approximate circle C, that is to the right of the surface of the wall W.

By having the localization positions of the voices of the remote participants set based on the localizable regions set in this manner, a situation where the voices of the remote participants are heard from positions where the wall is present can be prevented from occurring.

The regions to exclude from the localizable region setting are not limited to regions where walls are present. Various regions which should not be used as localization positions of the voices of remote participants are excluded from the setting of the localizable regions.

For example, in an environment where a participant in a conference is walking on a sidewalk, when the direction of a road is detected, the region on the road side is excluded from being set as a localizable region in order to avoid a situation where an accident occurs or the participant cannot hear due to noise.

Additionally, in an environment where a participant in a conference is present on a station platform, if a location of a train track is detected, the region on the train track side is excluded from being set as a localizable region.

Furthermore, in an environment in which a participant in a conference is in an entertainment facility that uses wide spaces, such as a theme park, if an entry prohibited area is detected, the entry prohibited area is excluded from being set as a localizable region.

In this manner, regions which are unnatural when set as the localization position of voice are set as exclusion regions that should not be set to the localization positions of the voices of remote participants. Setting the localizable regions to exclude the exclusion regions makes it possible to perform sound image localization suited to the environment in which the conference participants are present.

<Movement of Localization Positions when Number of Participants Increases or Decreases>

When the number of participants increases or decreases due to new participants being added or participants leaving the conference, the above-described calculations are performed in the communication management server 1 to update the localization positions of the voices of the remote participants. In this case, the localization position moves from a position Pold, which is the pre-update position, to a position Pnew, which is the post-update position.

Here, if the localization position of the voice of a remote participant is shifted instantaneously, depending on the real participant, the voice of the remote participant may, for example, be heard from an unexpected position, which is unnatural.

When the localization position of the voice of a remote participant moves, the movement of the localization position is presented through an animation. The voice animation is performed, for example, by changing the HRTF data used in the sound image localization processing, and sequentially moving the localization position of the voice (the position of the sound source) along a path from the position Pold to the position Pnew.

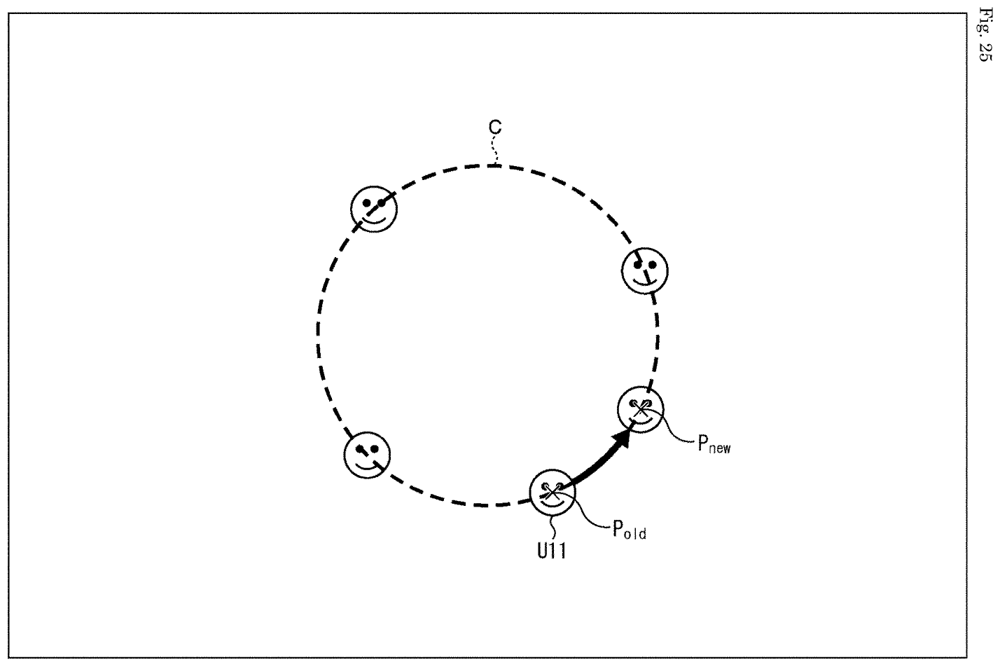

FIG. 25 is a diagram illustrating an example of the voice animation.

During the voice animation, if the sound source is moved linearly from the position Pold to the position Pnew, the sound source may cross near the center of the conversation circle, resulting in an unnatural conversation. Accordingly, as indicated by the bold line arrow in FIG. 25, for example, the sound source is moved by moving from the position Pold to the position Pnew along the arc of the approximate circle C.

By setting an arc-shaped path as the movement path for the position of the sound source and moving the position of the sound source while maintaining the distance from the center position of the approximate circle C, which serves as a reference position, the conversation circle formed on the approximate circle C can be maintained.

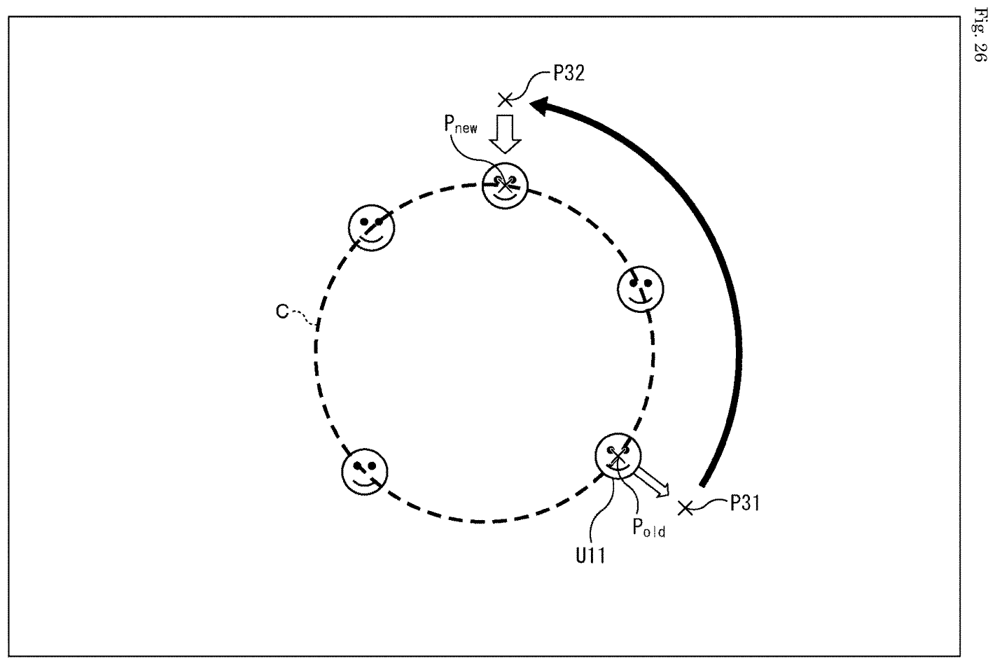

If a real participant is present on the arc-shaped path, the sound source of the voice output as an animation will overlap with the real participant, creating a sense of discomfort. Accordingly, as illustrated in FIG. 26, the movement path of the sound source is set so as to avoid the positions of real participants.

In the example in FIG. 26, a path is set taking the position Pold as a movement start position, with the sound source moving to a position P31 distanced from the center of the approximate circle C, and then moving in an arc shape while maintaining the distance from the center of the approximate circle C to the position P31. Additionally, a path is set in which when the sound source reaches a position P32 on a line passing through the center of the approximate circle C and the position Pnew, the sound source moves from the position P32 to the position Pnew.

Moving the sound source along such a movement path makes it possible to move the localization position of the voice of the remote participant in a natural manner without causing a sense of discomfort.

Such movement of the sound source is performed not only in at least one of situations when the number of real participants has increased or decreased and the number of remote participants has increased or decreased, but also when real participants have moved, for example. The sound source can be moved in response to changes in various circumstances pertaining to the participants.

### Other Examples

Screen Displays

A conference screen may be displayed in the display 207 of the client terminal 2 used by each participant, and the positional relationship with each participant may be presented as a result.

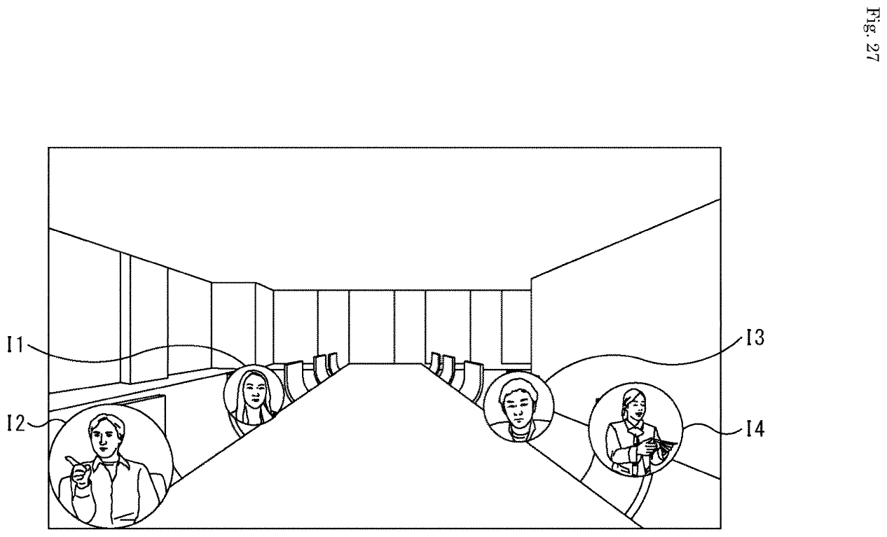

FIG. 27 is a diagram illustrating an example of the conference screen.

As illustrated in FIG. 27, the conference screen displays participant icons, which are information visually representing the participants, superimposed on a background image representing the place where the conference is being held. The positions of the participant icons on the screen are positions based on the positions of the corresponding participants.

In the example in FIG. 27, the participant icon is configured as a circular image including the face of the user. Each participant icon is displayed at a size corresponding to the distance from the position of the participant using the client terminal 2 to the position of the corresponding participant. Participant icons I1 to I4 represent real participants or remote participants, respectively.

### Rendering Example

Although the sound image localization processing including rendering and binaural processing is assumed to be performed by the client terminal 2, the processing may be performed by the communication management server 1. In other words, the sound image localization processing may be performed on the client terminal 2 side, or may be performed on the communication management server 1 side.

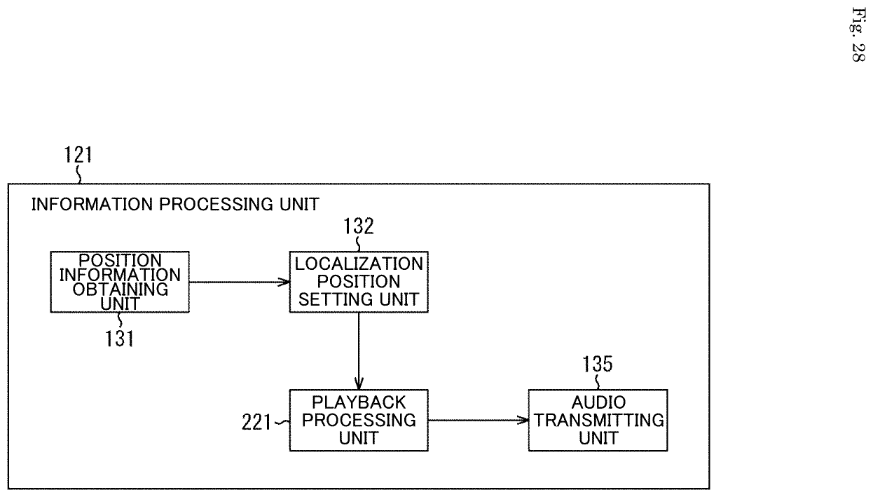

When the sound image localization processing is performed on the communication management server 1 side, the playback processing unit 221 in FIG. 12 is implemented in the information processing unit 121 of the communication management server 1, as illustrated in FIG. 28.

The audio receiving unit 241 (FIG. 12), which constitutes the playback processing unit 221 of the information processing unit 121, receives the audio data of the participant subject to the sound image localization processing. The localization position obtaining unit 242 also obtains the localization position set by the localization position setting unit 132.

The sound image localization processing unit 243 performs the sound image localization processing on the audio data received by the audio receiving unit 241 using the HRTF data in accordance with the localization position obtained by the localization position obtaining unit 242. The output control unit 245 transmits the channel-based audio data for two channels, i.e., L/R, for example, which is generated through the sound image localization processing, to the client terminal 2, and causes the audio data to be output from the earphones 3.

In this manner, the processing load on the client terminal 2 can be lightened by performing the sound image localization processing on the communication management server 1 side.

### Conversation Example

Although it is assumed that the conversation conducted by the plurality of users is a conversation in a remote conference, the techniques described above can be applied to various types of conversations as long as the conversations involve a plurality of people participating online, such as conversations during meals, conversations in lectures, and the like.

Program

The above-described series of processing can also be executed by hardware or software. When the series of processing is executed by software, a program constituting that software is installed, from a program recording medium, in a computer incorporated in dedicated hardware, a general-purpose personal computer, or the like.

The program to be installed is recorded on the removable medium 111 illustrated in FIG. 9, which is realized by an optical disk (a CD-ROM (Compact Disc-Read Only Memory), a DVD (Digital Versatile Disc), or the like), a semiconductor memory, or the like, and is provided in such a state. The program may also be provided over a wired or wireless transmission medium such as a local area network, the Internet, or digital satellite broadcasting. The program can be installed in advance in the ROM 102, the storage unit 108, or the like.

The program executed by the computer may be a program in which the processing is performed chronologically in the order described in the present specification, or may be a program in which the processing is performed in parallel or at a necessary timing such as when called.

In the present specification, “system” means a set of a plurality of constituent elements (devices, modules (components), or the like), and it does not matter whether or not all the constituent elements are provided in the same housing. Therefore, a plurality of devices contained in separate housings and connected over a network, and one device in which a plurality of modules are contained in one housing, are both “systems”.

The effects described in the present specification are merely exemplary and not intended to be limiting, and other effects may be provided as well.

The embodiments of the present technique are not limited to the above-described embodiments, and various modifications can be made without departing from the essential spirit of the present technique.

For example, the present technique may be configured through cloud computing in which a plurality of devices share and cooperatively process one function over a network.

In addition, each step described with reference to the foregoing flowcharts can be executed by a single device, or in a distributed manner by a plurality of devices.

Furthermore, when a single step includes a plurality of processes, the plurality of processes included in the single step can be executed by a single device, or in a distributed manner by a plurality of devices.

### Combination Example of Configuration

The present technique can also be configured as follows.

(1)

An information processing apparatus including:
a sound image localization processing unit that localizes a sound image of a voice of a remote participant, who is participating remotely in a conversation conducted in a predetermined space, to a position different from a position of a real participant who is a participant present in the predetermined space.

(2)

The information processing apparatus according to (1), further including:
a localization position setting unit that sets a localization position of the sound image of the voice of the remote participant based on the position of the real participant.

(3)

The information processing apparatus according to (2),
wherein the localization position setting unit sets the localization position to a position distanced from the position of each real participant.

(4)

The information processing apparatus according to (2) or (3),
wherein the localization position setting unit sets the localization position of the sound image of the voice of each of a plurality of the remote participants to a distanced position.

(5)

The information processing apparatus according to any one of (2) to (4),
wherein the localization position setting unit sets the localization position within a region excluding an exclusion region set in accordance with an environment of the predetermined space.

(6)

The information processing apparatus according to any one of (2) to (5),
wherein the localization position setting unit moves the localization position in response to a change in a situation of a participant in the conversation.

(7)

The information processing apparatus according to (6),
wherein the localization position setting unit moves the localization position from a movement start position to a movement destination position while maintaining a distance from a reference position.

(8)

The information processing apparatus according to (7),
wherein when the real participant is present in a path from the movement start position to the movement destination position, the localization position setting unit moves the localization position while avoiding the position of the real participant.

(9)

The information processing apparatus according to (1),
wherein the sound image localization processing unit localizes the sound image of the voice of the remote participant to a localization position set based on the position of the real participant.

(10)

The information processing apparatus according to (9),
wherein the sound image localization processing unit localizes the sound image of the voice of the remote participant to the localization position set to a position distanced from the position of each real participant.

(11)

The information processing apparatus according to (9) or (10),
wherein the sound image localization processing unit localizes the sound image of the voice of each of a plurality of the remote participants to a distanced position.

(12)

The information processing apparatus according to any one of (9) to (11),
wherein the sound image localization processing unit localizes the sound image of the voice of the remote participant to a position within a region excluding a exclusion region set in accordance with an environment of the predetermined space.

(13)

The information processing apparatus according to any one of (1) to (12), further including:
an output control unit that causes the voice of the remote participant to be output from an output device used by the real participant.

(14)

An information processing method including:
localizing a sound image of a voice of a remote participant, who is participating remotely in a conversation conducted in a predetermined space, to a position different from a position of a real participant who is a participant present in the predetermined space, the localizing being performed by an information processing apparatus.

(15)

A program for causing a computer to execute processing of:
localizing a sound image of a voice of a remote participant, who is participating remotely in a conversation conducted in a predetermined space, to a position different from a position of a real participant who is a participant present in the predetermined space.

### REFERENCE SIGNS LIST

1 Communication management server
2 Client terminal
3 Earphones
121 Information processing unit
131 Position information obtaining unit
132 Localization position setting unit
133 Localization position information transmitting unit
134 Audio receiving unit
135 Audio transmitting unit
211 Information processing unit
221 Playback processing unit
222 Audio transmitting unit
223 User position detecting unit
241 Audio receiving unit
242 Localization position obtaining unit
243 Sound image localization processing unit
244 HRTF data storage unit
245 Output control unit

1. An information processing apparatus comprising:
a sound image localization processing unit that localizes a sound image of a voice of a remote participant, who is participating remotely in a conversation conducted in a predetermined space, to a position different from a position of a real participant who is a participant present in the predetermined space.

2. The information processing apparatus according to claim 1, further comprising:
a localization position setting unit that sets a localization position of the sound image of the voice of the remote participant based on the position of the real participant.

3. The information processing apparatus according to claim 2,
wherein the localization position setting unit sets the localization position to a position distanced from the position of each real participant.

4. The information processing apparatus according to claim 2,
wherein the localization position setting unit sets the localization position of the sound image of the voice of each of a plurality of the remote participants to a distanced position.

5. The information processing apparatus according to claim 2,
wherein the localization position setting unit sets the localization position within a region excluding an exclusion region set in accordance with an environment of the predetermined space.

6. The information processing apparatus according to claim 2,
wherein the localization position setting unit moves the localization position in response to a change in a situation of a participant in the conversation.

7. The information processing apparatus according to claim 6,
wherein the localization position setting unit moves the localization position from a movement start position to a movement destination position while maintaining a distance from a reference position.

8. The information processing apparatus according to claim 7,
wherein when the real participant is present in a path from the movement start position to the movement destination position, the localization position setting unit moves the localization position while avoiding the position of the real participant.

9. The information processing apparatus according to claim 1,
wherein the sound image localization processing unit localizes the sound image of the voice of the remote participant to a localization position set based on the position of the real participant.

10. The information processing apparatus according to claim 9,
wherein the sound image localization processing unit localizes the sound image of the voice of the remote participant to the localization position set to a position distanced from the position of each real participant.

11. The information processing apparatus according to claim 9,
wherein the sound image localization processing unit localizes the sound image of the voice of each of a plurality of the remote participants to a distanced position.

12. The information processing apparatus according to claim 9,
wherein the sound image localization processing unit localizes the sound image of the voice of the remote participant to a position within a region excluding a exclusion region set in accordance with an environment of the predetermined space.

13. The information processing apparatus according to claim 1, further comprising:
an output control unit that causes the voice of the remote participant to be output from an output device used by the real participant.

14. An information processing method comprising:
localizing a sound image of a voice of a remote participant, who is participating remotely in a conversation conducted in a predetermined space, to a position different from a position of a real participant who is a participant present in the predetermined space, the localizing being performed by an information processing apparatus.

15. A program for causing a computer to execute processing of:
localizing a sound image of a voice of a remote participant, who is participating remotely in a conversation conducted in a predetermined space, to a position different from a position of a real participant who is a participant present in the predetermined space.
